(19) United States
(12) Patent Application Publication
(10) Pub. No.: US 2026/0228917 A1
(43) Pub. Date: Aug. 6, 2026

(54) METHOD FOR CALIBRATING AN IMAGE ACQUISITION DEVICE

(71) Applicant: AUMOVIO Autonomous Mobility Germany GmbH, Ingolstadt (DE)

(72) Inventors: Bilal HIJAZI, Toulouse (FR); Branham MOUATA, Toulouse (FR); Simon DEMMER, Toulouse (FR)

(73) Assignee: AUMOVIO Autonomous Mobility Germany GmbH, Ingolstadt (DE)

(21) Appl. No.: 19/151,401

(22) PCT Filed: Feb. 9, 2024
(86) PCT No.: PCT/EP2024/053297

§ 371 Date: Jul. 28, 2025

(30) Foreign Application Priority Data
Feb. 16, 2023 (FR) FR2301431

(51) Int. Cl. G06T 7/80

(52) U.S. Cl. CPC G06T 7/80

(57) ABSTRACT

A method for calibrating an image acquisition device, including determining the distance between the image acquisition device and a reference plane. The method including: acquiring at least two images of a calibration pattern located, for each image, at different distances from the image acquisition device and a constant distance from the reference plane, and having a plurality of characteristic points, preferably aligned, at different distances from the reference plane; and for each characteristic point, determining the difference between the positions of the same characteristic point from one image to another; and selecting certain characteristic points according to a predetermined condition; and estimating the distance from the acquisition device to the reference plane on the basis of the respective differences at the selected characteristic points.

### CROSS REFERENCE TO RELATED APPLICATIONS

This application is the U.S. National Phase Application of PCT International Application No. PCT/EP2024/053297, filed Feb. 9, 2024, which claims priority to French Patent Application No. 2301431, filed Feb. 16, 2023, the contents of such applications being incorporated by reference herein.

### FIELD OF THE INVENTION

The present disclosure relates to a method for calibrating an image acquisition device, an associated calibration device, and an associated computer program product.

### BACKGROUND OF THE INVENTION

Many technologies are currently being developed to assist drivers in driving vehicles, for example by providing them with additional information relating to their environment through various on-board sensors. These technologies are also required in the context of fully autonomous vehicles.

These sensors must be calibrated correctly to enable correct processing of the information.

This applies particularly to the image acquisition devices of these vehicles; their placement and orientation may vary from vehicle to vehicle and it is necessary to calibrate them correctly.

A plurality of calibration methods are known in the prior art for determining the position and orientation of an image acquisition device.

Amongst these, the use of the Levenberg-Marquardt algorithm in calibration applications is well known.

However, to determine the position and orientation in relation to a reference of an image acquisition device, this method has a plurality of disadvantages. Indeed, a strong correlation can first be found in the determination of the position with that of the orientation, thus bringing imprecision into the results. In addition, this optimization algorithm can also be costly in terms of time and computing resources when applied to a plurality of parameters.

### SUMMARY

The present disclosure aims to overcome the disadvantages of the prior art by proposing a method and a device for calibrating an image acquisition device which are simple in their design and in their mode of operation, and are reliable and fast.

A method is proposed for calibrating an image acquisition device, comprising determining the distance between the image acquisition device and a reference plane, the method comprising:
acquiring, by means of the acquisition device, at least two images of a calibration pattern comprising a plurality of characteristic points, the calibration pattern being positioned such that:
   when acquiring each image, a plurality of characteristic points are at different distances from the reference plane, and
   the calibration pattern is positioned at a constant distance from the reference plane and at two different distances from the image acquisition device respectively when acquiring the two images,
for a plurality of characteristic points of the pattern, determining a difference between the positions of the same characteristic point on the two images, and
selecting the characteristic points of the pattern of which the difference between the positions on the two images satisfies a predetermined condition, and
from the distances in relation to the reference plane of the selected characteristic points, and from the differences between the positions of these points on the two images, determining the distance from the image acquisition device to the reference plane.

In embodiments, the method comprises selecting a specific number of characteristic points of the pattern showing the differences between the positions on the two images, the smallest of all the characteristic points.

In embodiments, the method comprises selecting characteristic points of the pattern of which the differences between positions on the two images are less than a predetermined threshold.

In embodiments, the method comprises estimating, by means of linear regression, the parameters of a line connecting the distance from a point to the reference plane and the difference between the positions of that point on the two images, and determining the distance between the image acquisition device and the reference plane, the distance being the root of the line.

In some embodiments, once the distance from the image acquisition device to the reference plane is determined, the method also comprises determining an orientation of said device.

In variants of these embodiments, a device orientation is determined by an optimization method applied to the positions of characteristic points on at least one of the two images.

According to a different aspect, a computer program product is proposed, comprising code instructions for carrying out a method comprising:
receiving two images on which a calibration pattern is visible, the calibration pattern comprising a plurality of characteristic points,
for a plurality of characteristic points of the pattern, determining a difference between the positions of the same characteristic point on the two images, and
selecting the characteristic points of the pattern of which the difference between the positions on the two images satisfies a predetermined condition, and
from the distances from the selected characteristic points to the reference plane and the differences between the positions of these points on the two images, determining a distance between the image acquisition device and a reference plane,
   when it is executed by a processor.

Finally, according to a last aspect, a calibration device is proposed for an image acquisition device, comprising a calibration pattern comprising a plurality of characteristic points, and a computer, configured to carry out a method comprising:
receiving two images acquired by the image acquisition device, on which a calibration pattern is visible, the calibration pattern comprising a plurality of characteristic points,
for a plurality of characteristic points of the pattern, determining a difference between the positions of the same characteristic point on the two images, and
selecting the characteristic points of the pattern of which the difference between the positions on the two images satisfies a predetermined condition, and
from the distances from the selected characteristic points to the reference plane and the differences between the positions of these points on the two images, determining a distance between the image acquisition device and a reference plane.

The proposed method serves to determine the distance from the image acquisition device to a reference plane with increased precision and reduced resource requirement compared to the prior art.

In addition, unlike the Levenberg-Marquardt algorithm, the distance calibration is independent from the orientation of the image acquisition device, thus ensuring a more accurate result.

### BRIEF DESCRIPTION OF THE DRAWINGS

Other features, details and advantages will become apparent from a reading of the following detailed description, and with reference to the attached drawings, in which:

FIG. 1 shows a flowchart of a method for calibrating an image acquisition device according to one embodiment.

FIG. 2 shows a calibration device of an image acquisition device according to one embodiment.

FIG. 3 shows schematically the principle of the calibration method of an image acquisition device according to one embodiment.

FIG. 4 shows a front view of a pattern with a plurality of characteristic points according to one embodiment.

FIG. 5 shows a table taking into account the performance of the precision of the method according to the invention.

### DESCRIPTION OF THE EMBODIMENTS

Reference is now made to FIG. 1, which shows schematically the main steps of a method for calibrating an image acquisition device according to one particular embodiment.

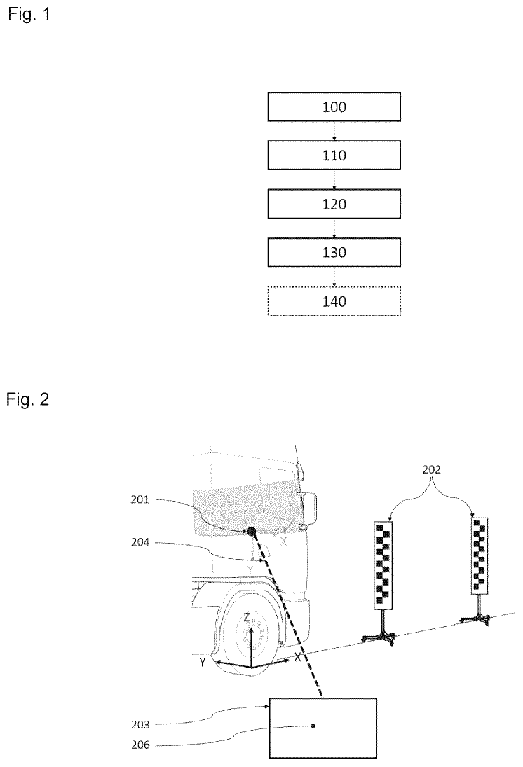

With reference to FIG. 2, the method is carried out by a calibration device comprising the image acquisition device 201, which can be, for example, a camera and a processing unit 203, comprising at least one computer and a memory storing the code instructions 206 in order to carry out the steps of the calibration method.

The calibration method is carried out to determine the distance between the image acquisition device and a reference plane. In one particular embodiment, the reference plane is horizontal, and the distance determined is the height of the image acquisition device relative to the horizontal. Alternatively, the reference plane can be a vertical plane, and the distance from the reference plane is a distance according to the direction of the normal of the plane concerned.

In the example application of the method shown in FIG. 2, the image acquisition device is a camera installed on-board a land vehicle, and the calibration method is designed to determine the height of the camera from the ground.

The various steps of the method for calibrating the acquisition device 201 are carried out by executing code instructions of a software program 206 on a remote processing unit 203, connected to the image acquisition device 201 by a communication link 204.

According to variants, this link 204 can be wired, having, for example, a USB protocol, or wireless, having, for example, a Bluetooth or Wi-Fi protocol. According to some variants, this link 204 can be an ad hoc communication system.

In a different variant, the computer 203 is directly integrated into the image acquisition device 201, and the link 204 is then inside said device 201.

In the embodiments, the computer 203 consists of at least one processor having a computing core allowing it to execute, at least partially, code instructions from the software program 206 in order to carry out the calibration method steps. In one variant, said computer 203 comprises a graphics processor.

The method comprises acquiring 100, by means of the image acquisition device 201, at least two images of a calibration pattern 202 placed at a constant distance from a reference plane but at different distances from the device. With reference to FIG. 4, a non-limiting example of a calibration pattern is shown, comprising a set of characteristic points 400. Characteristic points are points having a known and identifiable position on the pattern (for example, vertices of polygons or centers of circles). To carry out the method, the characteristic points that are used are preferably all aligned along the same axis which, during the image acquisition, is positioned perpendicular to the reference plane, so that the characteristic points are located at different distances from the reference plane. The acquisition of the images of the pattern thus provides two images on which the reference points are visible.

In one variant, step 100 comprises acquiring a single image of at least two identical patterns such that said patterns can be visible simultaneously to the image acquisition device, the two patterns being located at the same constant distance from the reference plane but at different distances from the image acquisition device.

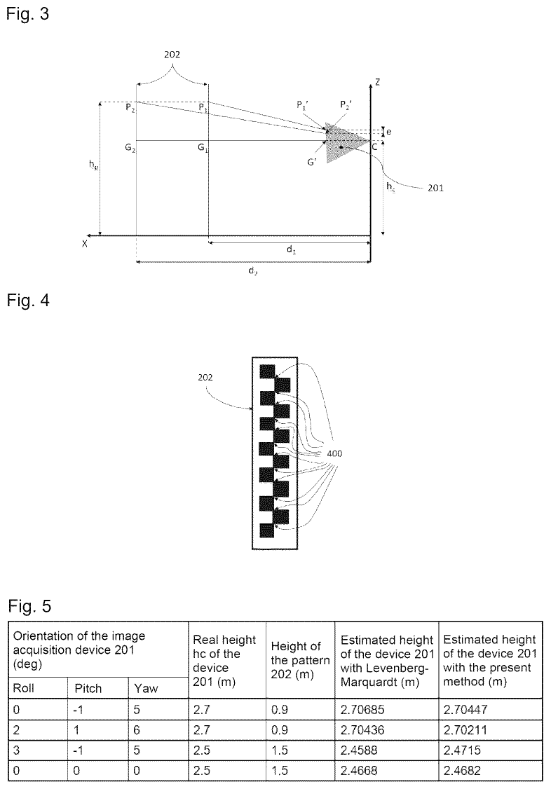

From this image or these images acquired in step 100, the method can determine the height of the image acquisition device according to the following principle, illustrated in one variant by the schematic view shown in FIG. 3.

A characteristic point P of the pattern 202 located at a distance hp from the reference plane is assumed. This point is denoted P₁ when the pattern is at a distance d₁ from the image acquisition device 201 in C, and P₂ when the pattern is at a distance d₂. It should be noted that, for the present variant shown, the pattern is moved away such that C is coplanar to the plane of the pattern translation (plane formed by the characteristic points of the pattern before and after translation).

A first image acquisition of the pattern 202 at a distance d₁ produces a point P₁′, a projection on the image of the point P₁.

A second image of the pattern 202 at distance de similarly produces a point P₂′, a projection on the image of point P₂.

The difference e, the distance between the projections P₁′ and P₂′, is zero when the points P₁ and P₂ have the height hp, which is the height of the image acquisition device 201. This results in hₚ=h_{c} and it is noted that the particular positions of these points G₁ and G₂ have the same projection G′.

In one variant (not shown) where C is not coplanar with the plane of translation of the pattern, the difference e refers to the distance between two new projections of the points P₁′ and P₂′ on the axis passing through the center of the image and forming with C a plane perpendicular to the image plane and the reference plane. Thus, G₁ and G₂ have a different first projection on the image plane, and a coincident second projection on the same axis.

For positions of P₁ and P₂ close to points G₁ and G₂ respectively, the difference e is linearly related to the distance hₚ. This results in e=a*hₚ+b where a and b are the parameters of the line which links the difference e to the distance hₚ.

Also, for points P₁ and P₂ coinciding with points G₁ and G₂, respectively, the results in hₚ=h_{c}, and e=a*h_{c}+b=0. The distance h_{c} is then referred to as the root solution of the line. And the following is deduced h_{c}=−b/a.

The principle of the method of the present disclosure is thus to estimate the positions of points G₁ and G₂, and therefore the distance h_{c} of the image acquisition device 201 from different characteristic points P₁ and P₂, respectively, close to points G₁ and G₂. In other words, the principle of the method of this disclosure is to thus estimate the positions of points G₁ and G₂, and therefore the distance h_{c} of the image acquisition device 201 from different characteristic points P₁ and P₂, these points P₁ and P₂ not being confused with points G₁ and G₂ respectively.

Step 110 thus comprises determining the non-zero differences e, from one photo to another, between the positions of a plurality of characteristic points of the pattern 202.

If, for example, the method aims to determine the height of the image acquisition device 201 with two images, step 110 aims to determine, for a plurality of characteristic points of the pattern 202, the distance e separating the projections P₁′ and P₂′ from each characteristic point.

The method then comprises a step 120 of selecting a plurality of characteristic points of which the difference calculated in the previous step satisfies a predetermined condition. This selection condition provides a plurality of points of which the distance hₚ to the reference plane is close enough to the distance h_{c} of the image acquisition device 201 to be considered linearly related to their respective difference e.

In one embodiment of step 120, the points having respective differences e as an absolute value below a predetermined threshold are selected.

Alternatively, in step 120, points having respective differences as an absolute value less than a predetermined percentile can be selected.

Alternatively, step 120 comprises selecting a determined number of points, for example between two and five points, for example between two and three points of which the differences e separating the projections of the points are minimal among the set of points for which these differences have been calculated.

In one embodiment, for example, in which the height of a camera 201 is to be determined, in step 120, the three points of which the respective differences e as an absolute value are the smallest, i.e. the three points of which the heights hₚ are the closest to h_{c}, that of the camera 201, are selected.

The method comprises determining 130 the distance h_{c} from the image acquisition device 201 to the reference plane from the differences calculated in step 110 for the points selected in step 120, and the distance from these points to the reference plane during the image acquisition.

This is done by determining the equation of a line connecting, for a given characteristic point, the difference between the projection of the point on the two images with the distance from the characteristic point to the reference plane. This determination can be performed, in the case where two characteristic points were selected in step 120, by linear interpolation, or, when three or more points were selected in step 120, by linear regression.

Once the equation of the line is determined, the distance h_{c} from the image acquisition device 201 to the reference plane is determined by calculating the root of the line. This estimation is advantageously obtained more quickly and more precisely than is possible in the prior art.

In embodiments, determining the distance between the image acquisition device and the reference plane can be followed by a step 140 of determining the orientation of the image acquisition device, for example by applying a minimization technique, for example the Levenberg-Marquardt algorithm.

The table shown in FIG. 5 reflects the performance of the precision of the present method in determining the height of a camera relative to the ground, compared to the use of the Levenberg-Marquardt algorithm.

From the results set out in the table in FIG. 5, it is evident that the height of the device 201 estimated using the present method is closer to the actual height of the device 201 than that estimated with the techniques of the prior art, for different configurations of the orientation of the image acquisition device 201 and of the pattern height 202.

It should be noted that non-linear minimization algorithms are also generally more time-consuming than their linear counterparts. This applies particularly to the present method.

1. A method for calibrating an image acquisition device, comprising determining the distance between the image acquisition device and a reference plane, the method comprising:
acquiring, by the image acquisition device, at least two images of a calibration pattern comprising a plurality of characteristic points, the calibration pattern being positioned such that:
during the acquisition of each image, a plurality of characteristic points have different distances from the reference plane, and
the calibration pattern is positioned at a constant distance from the reference plane and at two different distances from the image acquisition device respectively during the acquisition of the two images,
for a plurality of characteristic points of the pattern, determining a difference (e) between the positions of the same characteristic point on the two images, and
selecting the characteristic points of the pattern of which the difference (e) between the positions on the two images satisfies a predetermined condition, and
from the distances from the reference plane of the selected characteristic points and the differences (e) between the positions of these points on the two images, determining the distance (h_{c}) of the image acquisition device from the reference plane.

2. The method as claimed in claim 1, comprising selecting a certain number of characteristic points of the pattern showing the differences (e) between the positions on the two images, the smallest among the set of characteristic points.

3. The method as claimed in claim 1, comprising selecting the characteristic points of the pattern of which the differences (e) between the positions on the two images are less than a predetermined threshold.

4. The method as claimed in claim 1, comprising estimating, by linear regression, the parameters of a line connecting the distance from a point to the reference plane and the difference between the positions of that point on the two images, and determining the distance (h_{c}) from the image acquisition device to the reference plane, said distance (h_{c}) being the root of the line.

5. The method as claimed in claim 1, further comprising, once the distance (h_{c}) from the image acquisition device to the reference plane has been determined, determining an orientation of said device.

6. The method as claimed in claim 5, in which an orientation of the device is determined by an optimization method applied to the positions of the characteristic points on at least one of the two images.

7. A non-transitory computer program product, comprising code instructions for carrying out a method comprising:
receiving two images on which a calibration pattern is visible, the calibration pattern comprising a plurality of characteristic points,
for a plurality of characteristic points of the pattern, determining a difference (e) between the positions of the same characteristic point on the two images, and
selecting the characteristic points of the pattern of which the difference (e) between the positions on the two images satisfies a predetermined condition, and
on the basis of the distances from the selected characteristic points to the reference plane and the differences (e) between the positions of these points on the two images, determining a distance (h_{c}) between the image acquisition device and a reference plane,
when it is executed by a processor.

8. A calibration device of an image acquisition device, comprising a calibration pattern comprising a plurality of characteristic points, and a computer, configured to carry out a method comprising:
receiving two images acquired by the image acquisition device, on which a calibration pattern is visible, the calibration pattern comprising a plurality of characteristic points,
for a plurality of characteristic points of the pattern, determining a difference (e) between the positions of the same characteristic point on the two images, and
selecting the characteristic points of the pattern of which the difference (e) between the positions on the two images satisfies a predetermined condition, and
from the distances of the selected characteristic points to the reference plane and the differences between the positions of these points on the two images, determining a distance (h_{c}) between the image acquisition device and a reference plane.
